(19) United States
(12) Patent Application Publication
(10) Pub. No.: US 2025/0068337 A1
(43) Pub. Date: Feb. 27, 2025

(54) METHODS AND APPARATUS TO PERSISTENT PLATFORM SERVICE RECORDS

(71) Applicant: Intel Corporation, Santa Clara, CA (US)

(72) Inventors: Matthew I. Royer, Portland, OR (US); Barak Einav, Jerusalem (IL); Tsippy Mendelson, Jerusalem (IL); Narendra K. Vanguput, Bangalore (IN); Garritt C. Binder, Loomis, CA (US); Moorthy Rajesh, Folsom, CA (US); Lili Ma, Shanghai (CN); Hemant Desai, Gilbert, AZ (US); Robert Vaughn, Portland, OR (US)

(21) Appl. No.: 18/478,706

(22) Filed: Sep. 29, 2023

(30) Foreign Application Priority Data
Aug. 21, 2023 (IN) 202341056025

(51) Int. Cl. G06F 3/06

(52) U.S. Cl. CPC G06F 3/0622; G06F 3/0655; G06F 3/0679

(57) ABSTRACT

Systems, apparatus, articles of manufacture, and methods are disclosed to manage and securely store platform service records. An apparatus for monitoring a compute device, the apparatus comprising interface circuitry, non-volatile flash memory, machine readable instructions, and programmable circuitry to at least one of instantiate or execute the machine readable instructions to analyze telemetry data obtained via a sensor of the compute device, the analyzing of the telemetry data to detect an undesired event, and storing, in response to detection of the undesired event, the telemetry data in a ledger, wherein the ledger is digitally signed to prevent unauthorized modification and stored in the non-volatile flash memory.

### RELATED APPLICATIONS

This patent arises from the national stage of India Provisional Application No. 202341056025, which was filed on Aug. 21, 2023. India Provisional Application No. 202341056025 is hereby incorporated herein by reference in its entirety. Priority to India Provisional Application No. 202341056025 is hereby claimed.

### FIELD OF THE DISCLOSURE

This disclosure relates generally to computing devices and, more particularly, to methods and apparatus to persistent platform service records.

### BACKGROUND

Keeping track of service records and usage information of a compute device is important for tracking wear and tear of a compute device. Typically, such service records and usage information (e.g., telemetry data) is stored and accessed at a later point in time to assess the life-span remaining on compute devices and their associated hardware.

### BRIEF DESCRIPTION OF THE DRAWINGS

FIG. 1 is a block diagram of an example environment in which an example compute device operates to monitor and store telemetry data.

FIG. 2 is a block diagram of an example telemetry controller of FIG. 1.

FIG. 3 is a diagram of an example process of monitoring and storing the telemetry data using the telemetry controller of FIG. 1 to protect the data against unauthorized tampering.

FIGS. 4, 5A, 5B, and/or 6 are flowcharts representative of example machine readable instructions and/or example operations that may be executed, instantiated, and/or performed by example programmable circuitry to implement the telemetry controller of FIG. 1.

FIG. 7 is a block diagram of an example processing platform including programmable circuitry structured to execute, instantiate, and/or perform the example machine readable instructions and/or perform the example operations of FIGS. 4, 5A, 5B, and/or 6 to implement the telemetry controller of FIG. 1.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4, 5A, 5B, and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

### DETAILED DESCRIPTION

Typically, compute devices store service records and usage information in memory that can be erased, reset, tampered with, etc. This causes issues when compute devices are leased and returned since customers are able to wipe the usage information and essentially hide the wear and tear on the compute device.

Such service records and usage information (e.g., telemetry data) can include intentional tampering of the compute device (e.g., intentional wiping of data) or un-intentional tampering such as swapping out a hard drive for another hard drive. Either method of tampering can lead to loss of service records in current implementations, where the records are stored in memory locations that can be accessed and modified.

Examples disclosed herein provide enable telemetry data (e.g., service records) to be stored in encrypted non-volatile flash memory and protected against unauthorized tampering. Such examples include signing/encrypting telemetry data ledgers and storing the ledgers in non-volatile flash memory that are accessible by authorized users and/or compute devices with the ability to decode the ledgers. Conversely, unauthorized users cannot access such ledgers. Additionally, examples disclosed herein provide a communication path to communicate the telemetry data ledger to external service providers to maintain a separate copy of the data ledger.

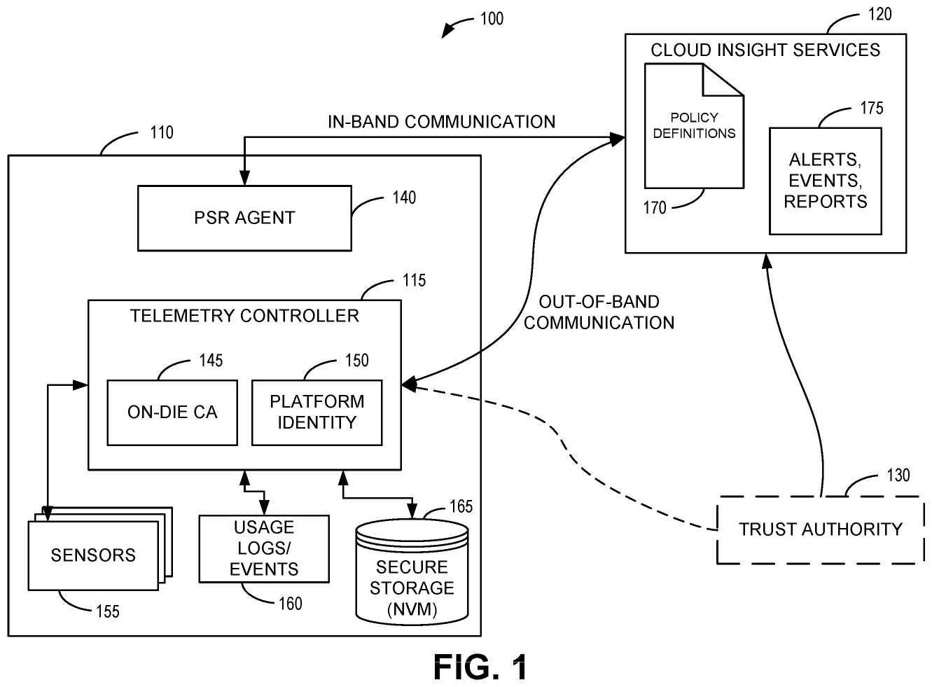

FIG. 1 is a block diagram of an example environment 100 in which an example compute device 110 operates to monitor and store telemetry data. The example compute device 110 of FIG. 1 includes an telemetry controller 115, a platform service record (PSR) agent 140, at least one sensor 155, a log/ledger of usage/events 160 of the compute device 110, and secure storage 165 (e.g., non-volatile memory (NVM)). The sensor(s) 155 can collect information about the usage and status of the compute device 110. Such usage and status information can include chassis intrusion (e.g., opening/removing of a laptop casing), excessive shock, working (e.g., S0, active) operation times, removal/replacement of hardware components, excessive temperature events, software changes, etc.

In some examples, the sensor(s) 155 can include hardware sensors for monitoring the health of hardware components (e.g., CPU health), pressure sensors, temperature sensors, etc. The compute device 110 can include any type of sensor 155 that can sense information related to the monitoring of the usage and status of the compute device 110. Sensor information is compiled via the telemetry controller 115 into a ledger (e.g., a list, a table, or any other form or organized collection of data) that is used to determine usage and status information of the compute device 110.

In examples disclosed herein, the telemetry controller 115 encrypts the ledger and stores the ledger in the secure storage 165 (e.g., non-volatile flash memory) to ensure that the ledger cannot be tampered with and/or modified. Such a tampering/modification could lead to inaccurate analyses of the usage and status of the compute device 110. Therefore, the telemetry controller 115 can digitally sign the ledger prior to storing in secure storage.

In examples disclosed herein, the telemetry controller 115 includes an on-die certification authority (CA) 145 to attest the ledger created by the telemetry controller 115 when the ledger is ready for analysis. The attestation of the ledger verifies that the ledger has not been tampered with/modified in any way by an unauthorized user or process.

The telemetry controller 115 also includes a platform identity 150. The platform identity 150 enables a user to verify that the ledger was authentically generated by the compute device 110. The use of the on-die CA 145 and the platform identity 150 ensures that the ledger is secured from unauthorized tampering and ensures that the ledger was not artificially stored through manipulation of the secure storage.

The example environment 100 also includes a cloud insight service 120 and a trust authority 130. The cloud insight service 120 is an external servicer of the compute device 110. In some examples, the compute device 110 communicates with the cloud insight service 120 to provide the signed ledger to the cloud insight service 120. This provides an alternate route for securely storing the ledger to prevent unauthorized tampering by removing the ledger from the local storage of the compute device 110.

The cloud insight service 120 includes policy definitions 170 and an external log 175. In examples disclosed herein, the policy definitions 170 include instructions on what sensors 155 the telemetry controller 115 is to monitor, indications of a platform (e.g., laptop, tablet, desktop, etc.) of the compute device 110, or any other instructions and/or indications to be used by the telemetry controller 115 for monitoring wear and usage data. The external log 175 is a log of information related to the execution of the telemetry controller 115 on the compute device 110 and/or a storage medium (e.g., memory allocation, external ledger, etc.) for storing the ledger communicated from the telemetry controller 115 to the cloud insight services 120.

In some examples, the trust authority 130 is a device manufacturer or original equipment manufacturer (OEM). In some examples, the trust authority 130 provides an initial provisioning/configuration for maintaining and storing the ledger throughout the life-cycle of the compute device 110.

As shown in the example of FIG. 1, the trust authority 130 communicates with the cloud insight services 120 and, in some examples, the compute device 110, the cloud insight services 120 communicates with the compute device 110, and the compute device 110 communicates with the cloud insight services 120. Any combination or alteration of the communication channels between the devices/mediums within the example of FIG. 1 can alternatively be used.

While examples disclosed herein relate particularly to recordation of wear and usage data, in some examples, other types of information about the compute device 110 may additionally or alternatively be recorded. For example, ownership information may be recorded in the ledger. In some examples, the ownership information may represent a transfer of ownership from one party to the next. Alternatively, the ownership information may represent a relinquishment of ownership of a current (or previous) party owning the device. Moreover, while ownership information may be recorded, other information about parties associated with a device (e.g., insurers, leasing parties, service agents, etc.) may be recorded.

The telemetry controller 115 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the telemetry controller 115 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the blocks of FIG. 1 may, thus, be instantiated at the same or different times. Some or all of the blocks of FIG. 1 may be instantiated, for example, in one or more threads executing concurrently on hardware and/or in series on hardware. Moreover, in some examples, some or all of the blocks of FIG. 1 may be implemented by microprocessor circuitry executing instructions and/or FPGA circuitry performing operations to implement one or more virtual machines and/or containers.

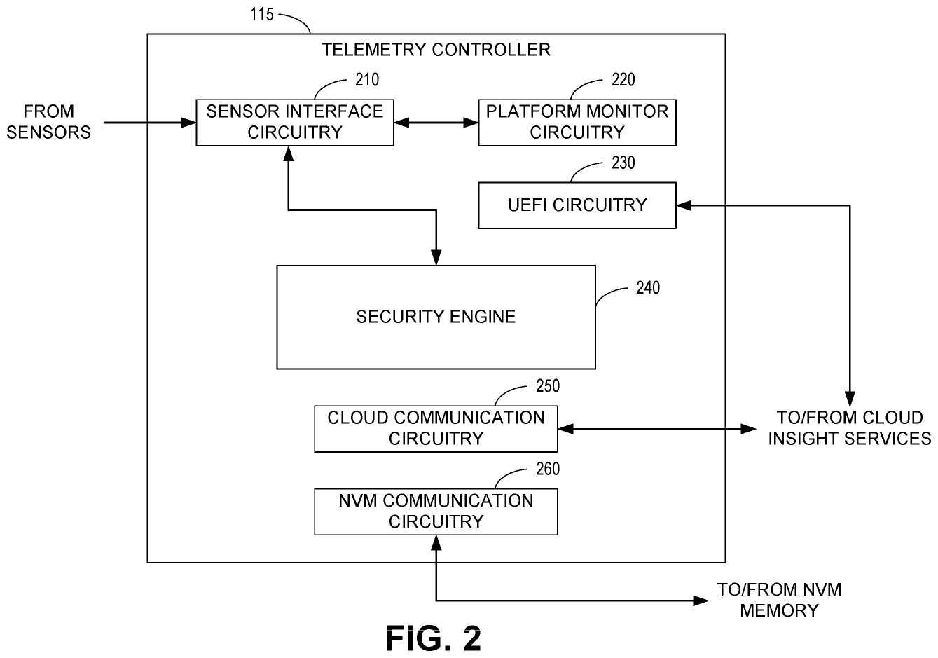

FIG. 2 is a block diagram of an example telemetry controller 115 of FIG. 1. In the example diagram of FIG. 2, the telemetry controller 115 includes sensor interface circuitry 210, platform monitor circuitry 220, Unified Extensible Firmware Interface (UEFI) circuitry 230, security engine 240, cloud communication circuitry 250, and non-volatile memory (NVM) communication circuitry 260.

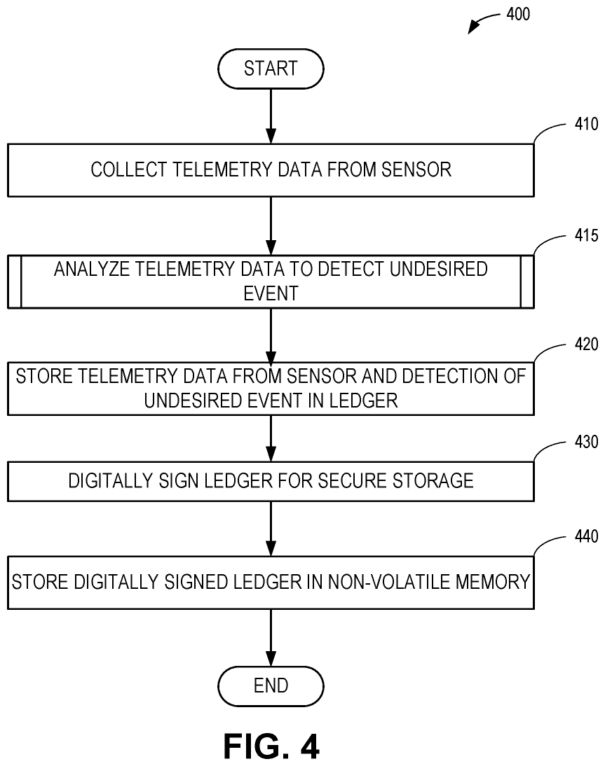

The sensor interface circuitry 210 communicates with the sensors 155 of the compute device 110 to receive sensor data from the sensors 155. In some examples, the sensor interface circuitry 210 is instantiated by programmable circuitry executing sensor interface instructions and/or configured to perform operations such as those represented by the flowchart of FIG. 4.

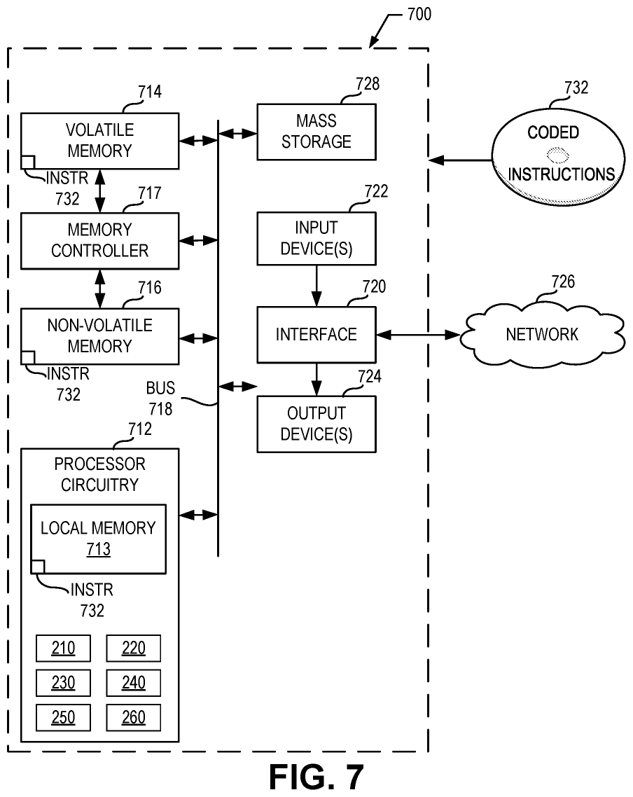

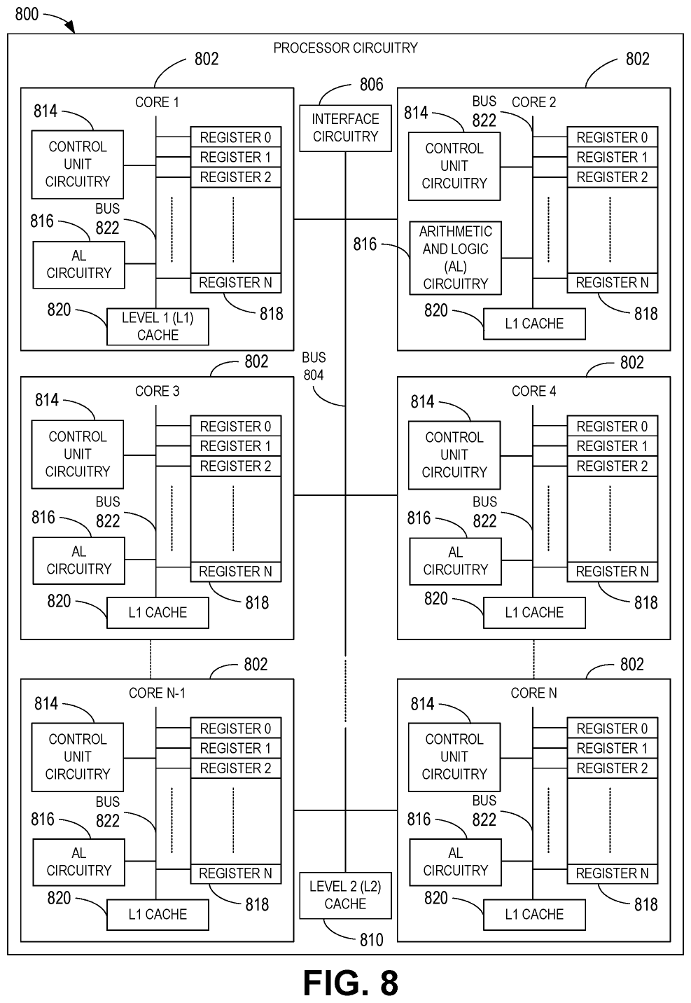

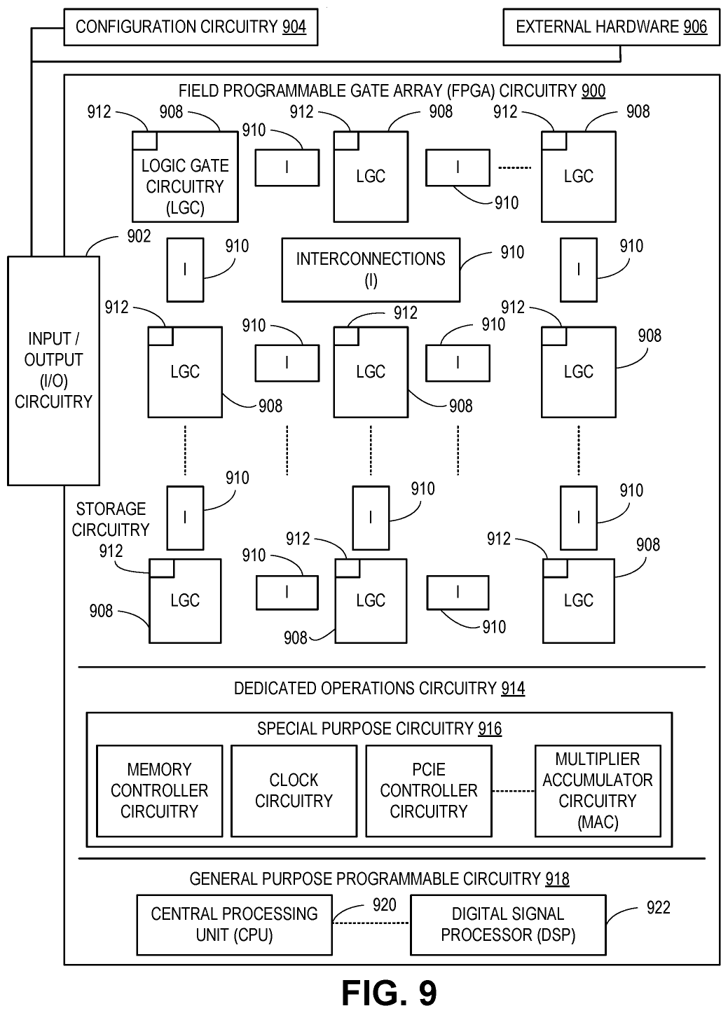

In some examples, the telemetry controller 115 includes means for obtaining telemetry data from the sensors 155. For example, the means for obtaining may be implemented by sensor interface circuitry 210. In some examples, the sensor interface circuitry 210 may be instantiated by programmable circuitry such as the example programmable circuitry 712 of FIG. 7. For instance, the sensor interface circuitry 210 may be instantiated by the example microprocessor 800 of FIG. 8 executing machine executable instructions such as those implemented by at least block 410 of FIG. 4. In some examples, the sensor interface circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the sensor interface circuitry 210 may be instantiated by any other combination of hardware, software, and/or firmware. For example, the sensor interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The platform monitor circuitry 220 collects information about the chassis of the sensors 155 of the compute device 110. The indicator information is used with the chassis information collected to analyze/determine whether an undesired event has occurred. In some examples, the chassis information includes whether the chassis has been opened/removed, excessive temperature events, display problems, sanitization events (e.g., attempted wiping of data on the compute device 110), etc. In some examples, the platform monitor circuitry 220 is instantiated by programmable circuitry executing platform monitor instructions and/or configured to perform operations such as those represented by the flowchart of FIG. 4.

In some examples, the telemetry controller 115 includes means for analyzing platform data regarding the compute device 110. For example, the means for analyzing may be implemented by platform monitor circuitry 220. In some examples, the platform monitor circuitry 220 may be instantiated by programmable circuitry such as the example programmable circuitry 712 of FIG. 7. For instance, the platform monitor circuitry 220 may be instantiated by the example microprocessor 800 of FIG. 8 executing machine executable instructions such as those implemented by at least block 410 of FIG. 4. In some examples, the platform monitor circuitry 220 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the platform monitor circuitry 220 may be instantiated by any other combination of hardware, software, and/or firmware. For example, the platform monitor circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The UEFI circuitry 230 communicates with the cloud insight services 120 to send sensor and/or chassis data to the cloud insight services 120, bypassing an analysis of the sensor and/or chassis data. In some examples, the UEFI circuitry 230 is instantiated by programmable circuitry executing sensor and/or chassis data bypass instructions and/or configured to perform operations such as those represented by the flowcharts of FIGS. 4 and 6.

In some examples, the telemetry controller 115 includes means for bypassing analyzing the chassis and/or telemetry data. For example, the means for bypassing may be implemented by UEFI circuitry 230. In some examples, the UEFI circuitry 230 may be instantiated by programmable circuitry such as the example programmable circuitry 712 of FIG. 7. For instance, the UEFI circuitry 230 may be instantiated by the example microprocessor 800 of FIG. 8 executing machine executable instructions such as those implemented by at least block 415 of FIG. 4 and blocks 620 and 630 of FIG. 6. In some examples, the UEFI circuitry 230 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the UEFI circuitry 230 may be instantiated by any other combination of hardware, software, and/or firmware. For example, the UEFI circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security engine 240 stored the undesired event information in the ledger and protects the ledger from unauthorized tampering. In some examples, the security engine 240 is instantiated by programmable circuitry executing event storing instructions and/or configured to perform operations such as those represented by the flowcharts of FIGS. 4, 5, and 6.

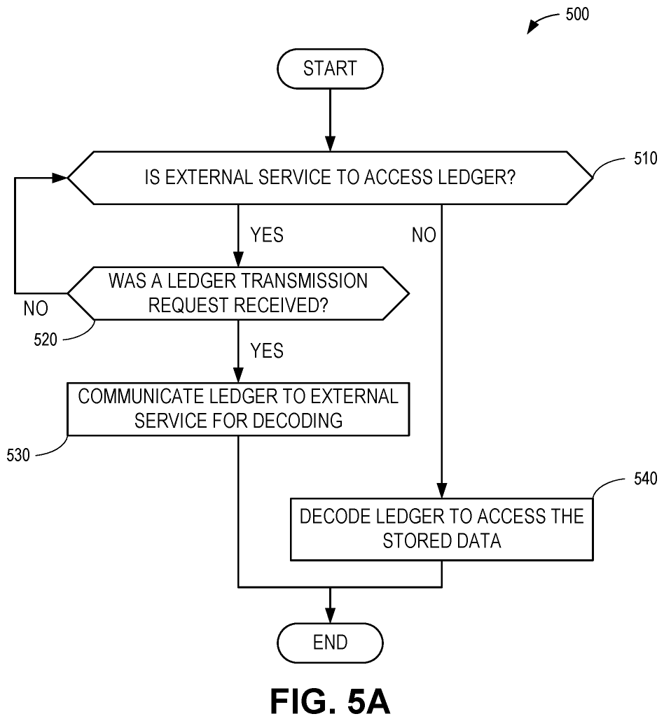

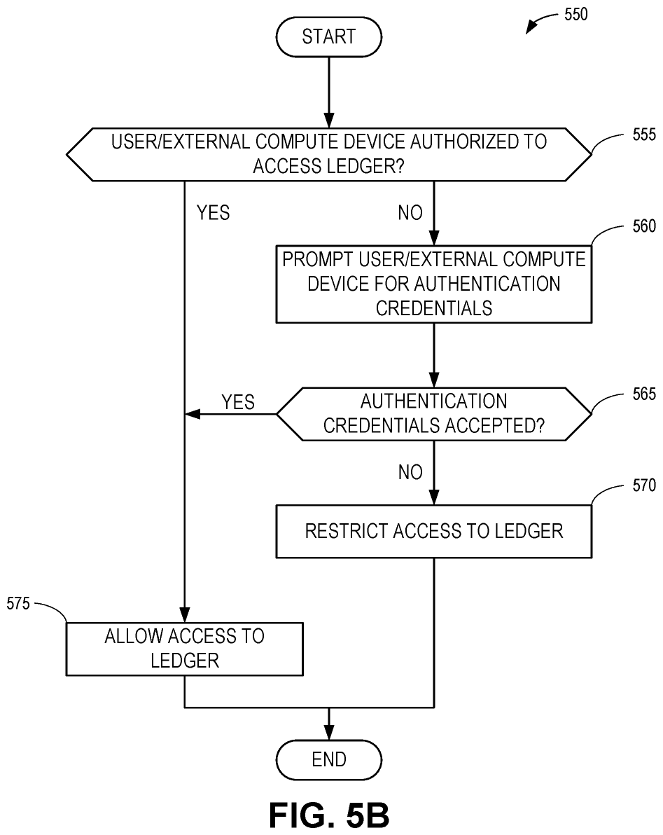

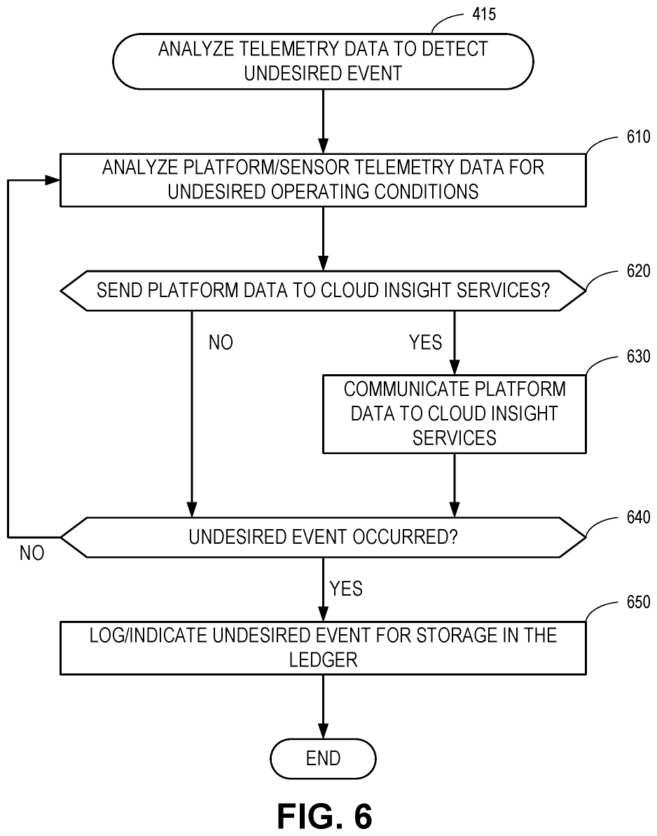

In some examples, the telemetry controller 115 includes means for storing undesired event information in a ledger including telemetry data. For example, the means for storing may be implemented by security engine 240. In some examples, the security engine 240 may be instantiated by programmable circuitry such as the example programmable circuitry 712 of FIG. 7. For instance, the security engine 240 may be instantiated by the example microprocessor 800 of FIG. 8 executing machine executable instructions such as those implemented by at least blocks 415, 420, and 430 of FIG. 4, block 540 of FIG. 5A, blocks 555, 560, 565, 570, and 575 of FIG. 5B, and blocks 610, 640, and 650 of FIG. 6. In some examples, the security engine 240 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security engine 240 may be instantiated by any other combination of hardware, software, and/or firmware. For example, the security engine 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the telemetry controller 115 also includes means for decoding the telemetry data within the ledger. For example, the means for decoding may be implemented by the security engine 240 so an authorized user may access the ledger and the information stored therewith.

The cloud communication circuitry 250 communicates with the cloud insight services 120 to send the ledger and receive instructions and/or indications. In some examples, the instructions and/or indications received include a request from the cloud insight services 120 to communicate the ledger, such a request to be processed by the cloud communication circuitry 250. In some examples, the cloud communication circuitry 250 is instantiated by programmable circuitry executing cloud communication instructions and/or configured to perform operations such as those represented by the flowchart of FIG. 5A.

In some examples, the telemetry controller 115 includes means for processing ledger transmission requests from the cloud insight services 120. For example, the means for processing may be implemented by cloud communication circuitry 250. In some examples, the cloud communication circuitry 250 may be instantiated by programmable circuitry such as the example programmable circuitry 712 of FIG. 7. For instance, the cloud communication circuitry 250 may be instantiated by the example microprocessor 800 of FIG. 8 executing machine executable instructions such as those implemented by at least blocks 510, 520, and 530 of FIG. 5A. In some examples, the cloud communication circuitry 250 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the cloud communication circuitry 250 may be instantiated by any other combination of hardware, software, and/or firmware. For example, the cloud communication circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The NVM communication circuitry 260 stores the ledger in non-volatile memory (NVM). In some examples, the NVM communication circuitry 260 is instantiated by programmable circuitry executing NVM communication instructions and/or configured to perform operations such as those represented by the flowchart of FIG. 4.

In some examples, the telemetry controller 115 includes means for storing the ledger in NVM. For example, the means for storing may be implemented by NVM communication circuitry 260. In some examples, the NVM communication circuitry 260 may be instantiated by programmable circuitry such as the example programmable circuitry 712 of FIG. 7. For instance, the NVM communication circuitry 260 may be instantiated by the example microprocessor 800 of FIG. 8 executing machine executable instructions such as those implemented by at least block 440 of FIG. 4. In some examples, the NVM communication circuitry 260 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the NVM communication circuitry 260 may be instantiated by any other combination of hardware, software, and/or firmware. For example, the NVM communication circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the telemetry controller 115 of FIG. 1 is illustrated in FIG. 2, one or more of the elements, processes, and/or devices illustrated in FIG. 2 may be combined, divided, re-arranged, omitted, eliminated, and/or implemented in any other way. Further, the example sensor interface circuitry 210, example platform monitor circuitry 220, example UEFI circuitry 230, example security engine 240, example cloud communication circuitry 250, example NVM communication circuitry 260, and/or, more generally, the example telemetry controller 115 of FIG. 2, may be implemented by hardware alone or by hardware in combination with software and/or firmware. Thus, for example, any of the example sensor interface circuitry 210, example platform monitor circuitry 220, example UEFI circuitry 230, example security engine 240, example cloud communication circuitry 250, example NVM communication circuitry 260, and/or, more generally, the example telemetry controller 115, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example telemetry controller 115 of FIG. 2 may include one or more elements, processes, and/or devices in addition to, or instead of, those illustrated in FIG. 2, and/or may include more than one of any or all of the illustrated elements, processes and devices.

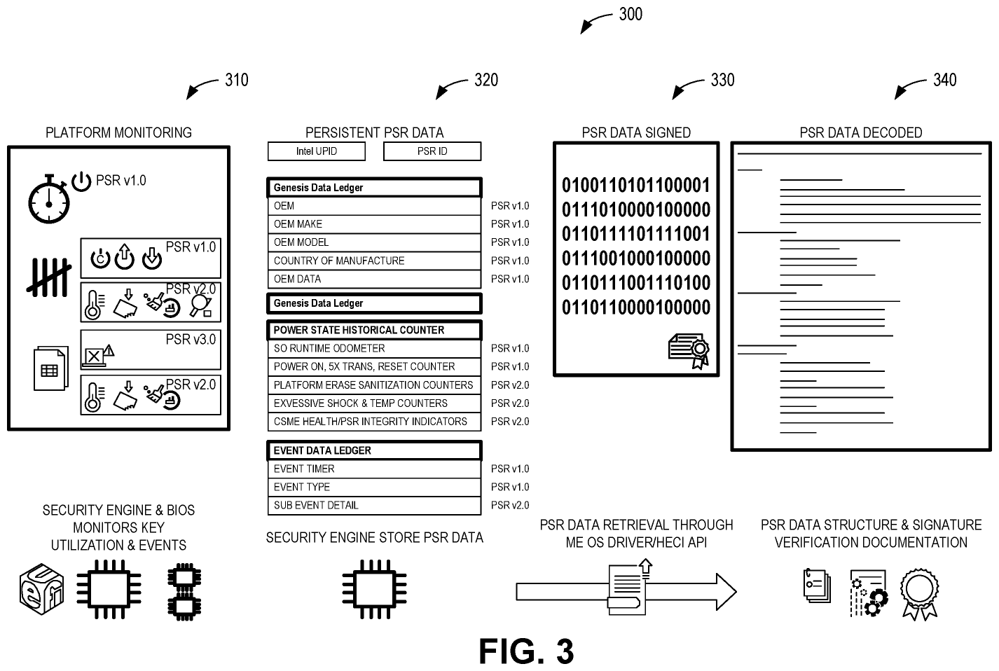

FIG. 3 is a diagram of an example process 300 for monitoring and storing the telemetry data using the telemetry controller 115 of FIG. 1 to protect the telemetry and/or chassis data against unauthorized tampering. In the example of FIG. 3, the telemetry controller 115 collects sensor data from the sensor(s) 155 on the compute device 110 (e.g., platform monitoring 310). This sensor data is persistently/continually stored in a ledger to maintain a record of usage and status information of the compute device 110 (e.g., persistent PSR data 320). The persistent ledger is then digitally signed such that no unauthorized users can access and/or modify/tamper with the ledger (e.g., PSR data signed 330). When the ledger is ready for viewing/analysis by an authorized user and/or compute device, the ledger is decoded so the sensor and/or chassis information, including whether an undesired event occurred, can be viewed (e.g., PSR data decoded 340).

Flowchart(s) representative of example machine readable instructions, which may be executed by programmable circuitry to implement and/or instantiate the telemetry controller 115 of FIG. 2 and/or representative of example operations which may be performed by programmable circuitry to implement and/or instantiate the telemetry controller 115 of FIG. 2, are shown in FIGS. 4, 5A, 5B, and/or 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 5A, 5B, and/or 6, many other methods of implementing the example telemetry controller 115 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4, 5A, 5B, and/or 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to collect and store telemetry data into a ledger. The example machine-readable instructions and/or the example operations 400 of FIG. 4 begin at block 410, at which the sensor interface circuitry 210 and/or the platform monitor circuitry 220 collects telemetry data from one or more sensors. In some examples, the sensors include pressure sensors, accelerometers, temperature sensors, contact sensors, etc. In some examples, the platform monitor circuitry 220 collects sensor information from the sensor interface circuitry 210 related to chassis intrusion events, allowing for a parallel path for determining different kinds of undesired events (e.g., excess temperature threats from overuse of the compute device 110 compared to attempts to break/physically open the compute device 110).

Once the sensor interface circuitry 210 has collected the telemetry data from the one or more sensors, the security engine 240 monitors the telemetry data to detect an undesired event. (Block 415). In some examples, the monitoring of the telemetry data includes comparing the data from the sensors to acceptable thresholds (e.g., temperature thresholds, CPU utilization thresholds, force thresholds, etc.) to determine if the compute device 110 has been subject to an undesired event such as excess temperature events, excess force events, etc.

Once the security engine 240 monitors the telemetry data from the sensors, the security engine 240 stores the telemetry data into a ledger. (Block 420). In some examples, the ledger is organized into a list, a table, a comma separated value (csv) file, or any other data structure for organizing data. The ledger is a generic term to define a compilation of data and not meant to be limiting as to a specific way of organizing data. In some examples, the ledger is organized/compiled by the security engine 240.

Once the security engine 240 has stored the telemetry data into the ledger, the security engine 240 digitally signs the ledger. (Block 430). In some examples, the digitally signing of the ledger encrypts the ledger so that an authorized user is required to decode the ledger to access the information stored within.

Once security engine 240 has digitally signed the ledger, the NVM communication circuitry 260 stores the digitally signed ledger in non-volatile flash memory. (Block 440). In examples disclosed herein, the storage of the ledger in non-volatile flash memory protects the signed ledger from unauthorized tampering. Such an example includes wiping/deleting the signed ledger, replacing the signed ledger, etc. In some examples, the non-volatile flash memory is not accessible through a user interface and an authorized user and/or compute device is necessarily required to access the signed ledger by executing commands to retrieve the signed ledger.

Once the NVM communication circuitry 260 stores the digitally signed ledger in non-volatile flash memory, the example operations 400 of FIG. 4 end. In some examples, the example operations 400 of FIG. 4 continue for as long as the compute device 110 is in use. Such an example will continually retrieve and securely store telemetry data in the ledger.

FIG. 5A is a flowchart representative of example machine readable instructions and/or example operations 500 that may be executed, instantiated, and/or performed by programmable circuitry to access and decode the digitally signed ledger. The example machine-readable instructions and/or the example operations 500 of FIG. 5A begin at block 510, at which the cloud communication circuitry 250 determines whether an external service is to access the ledger (e.g., the cloud insight service 120). In some examples, the external service sends a request to the telemetry controller 115 to request the signed ledger to be transmitted to the external service. In other examples, the telemetry controller 115 includes a list/log of approved external services for which to transmit the signed ledger to.

When the cloud communication circuitry 250 determines that an external service is to access the signed ledger (e.g., block 510 returns a result of YES), the cloud communication circuitry 250 determines whether a ledger transmission request was received. (Block 520). In some examples, where the telemetry controller 115 includes a list/log of approved external services, the ledger transmission request may be assumed and the signed ledger can be transmitted to the external service without a dedicated request indicator from the external service.

In other examples, where the external service is required to send a dedicated ledger transmission request, when the cloud communication circuitry 250 determines that no ledger transmission request was received (e.g., block 520 returns a result of NO), the cloud communication circuitry 250 continues to monitor whether an external service is to access the signed ledger (e.g., return to block 510).

When the cloud communication circuitry 250 determines that the external service is on the list/log of approves external services or when the cloud communication circuitry 250 receives a ledger transmission request (e.g., block 520 returns a result of YES), the cloud communication circuitry 250 communicates the signed ledger to the external service (e.g., the cloud insight service 120) for decoding. (Block 530). In some examples, the external service decodes the signed ledger at the external service, and thus the security engine 240 need not decode the signed ledger before sending the ledger. In other examples, the external service may transmit an additional request to decode the ledger prior to transmitting the ledger to the external service.

When the cloud communication circuitry 250 determines that an external service is not to access the signed ledger (e.g., block 510 returns a result of NO), then the security engine 240 decodes the signed ledger for the authorized user to access the telemetry data stored within. (Block 540). In some examples, the telemetry controller 115 requires an additional authentication request from a user attempting to decode/access the signed ledger. Such an example is described herein with reference to the on-die CA 145 and the platform identify 150 of the telemetry controller 115 of FIG. 1.

Once the ledger is transmitted to the external service or when the security engine 240 decodes the signed ledger, the example operations 500 of FIG. 5A end. The example operations 500 of FIG. 5A are repeatable to access any number of stored ledgers within the compute device 110.

FIG. 5B is a flowchart representative of example machine readable instructions and/or example operations 550 that may be executed, instantiated, and/or performed by programmable circuitry to determine whether a user and/or external compute device (e.g., the cloud insight services 120) can access the ledger. The example machine-readable instructions and/or the example operations 550 of FIG. 5B begin at block 555, at which the security engine 240 determines whether the user/external compute device is authorized to access the ledger when a user/external compute device is attempting to access the ledger. In some examples, ownership of the compute device 100 changes (e.g., the compute device 110 is sold/transferred/re-leased/etc. to another person, ownership of the compute device 110 is relinquished, etc.), and the data stored on the compute device 110 (e.g., telemetry data/ledger or other sensitive data) may need to be protected from the new owner/destroyed. In some examples, certain users and/or external compute devices (e.g., authorized technicians, host servers, manufacturer servers, etc.) are pre-authorized to access the ledger. Such examples allow for users and/or external compute devices to monitor a current state of the compute device 100 (e.g., real-time wear and usage information, damage indications, etc.).

When the security engine 240 determines that the user/external compute device is not authorized to access the ledger (e.g., block 555 returns a result of NO), the security engine 240 prompts the user/external compute device for authentication credentials. (Block 560). In some examples, the authentication credentials include a security code (e.g., multifactor authentication (MFA), a network access key, etc.) to gain access to the ledger. Any form of authentication protocol may be alternatively used herein to determine whether the user/external compute device can gain access to the ledger.

Once the security engine 240 prompts the user/external compute device for authentication credentials, the security engine 240 determines whether the authentication credentials have been accepted. (Block 565). In some examples, a user/external compute device may input incorrect authentication credentials, indicating that the attempt to access the ledger may be malicious or undesired.

When the security engine 240 determines that the authentication credentials have not been accepted (e.g., block 565 returns a result of NO), the security engine 240 restricts access to the ledger. (Block 570). In some examples, restricting access to the ledger includes booting the user/external compute device out of connection with the compute device 110 (e.g., a remote connection is terminated, a user is signed out of the compute device 110, the compute device 110 is locked from further access, etc.).

When the security engine 240 determines that the user/external compute device is authorized to access the ledger (e.g., block 555 returns a result of YES) or when the security engine 240 determines that the authentication credentials have been accepted (e.g., block 565 returns a result of YES), the security engine 240 allows the user/external compute device to access the ledger. (Block 575). In some examples, allowing access to the ledger includes decoding the ledger so the telemetry data can be viewed (e.g., prompting the security engine 240 to decode the ledger). In other examples, allowing access to the ledger includes allowing the ledger to be transferred to another device (e.g., across a network to an external computing device, to a universal serial bus (USB) storage device, etc.).

Once the security engine 240 restricts access to the ledger due to unaccepted authorization credentials or when the security engine 240 allows access to the ledger, the example operations 550 of FIG. 5B ends.

FIG. 6 is a flowchart representative of example machine readable instructions and/or example operations that may be executed, instantiated, and/or performed by programmable circuitry to monitor telemetry data and detect undesired events. The example machine-readable instructions and/or the example operations of FIG. 6 begin at block 610, at which the security engine 240 analyzes the platform and/or sensor telemetry data for undesired operating conditions. In some examples, the analysis includes determining whether operating temperatures have been exceeded, water damage has been detected, chassis intrusion events have occurred, etc.

Once the security engine 240 analyzes the data to determine whether an undesired operating condition has occurred, the UEFI circuitry 230 determines whether to chassis data directly to the cloud insight services 120. (Block 620). In some examples, where a catastrophic chassis event has occurred such as but not limited to water damage, force limits being exceeded (indicating the chassis is broken), etc., the UEFI circuitry 230 can directly transmit the information to the cloud insight services 120 before the information is compiled in the ledger. Such an example may be warranted where the compute device 110 is particularly important to an operation (e.g., a server housing sensitive information).

When the UEFI circuitry 230 determines that the platform/chassis data is to be sent directly to the cloud insight services 120, the UEFI circuitry 230 communicates the information to the cloud insight services 120. (Block 630). In some examples, a copy of the information is sent to the cloud insight services 120 and the original (e.g., originally detected on the compute device 110) is added to the ledger for analysis at a later time if desired.

Once the UEFI circuitry 230 has communicated the platform/chassis information to the cloud insight services 120 or when the UEFI circuitry 230 has determined that the information does not need to be communicated to the cloud insight services 120 (e.g., block 620 returns a result of NO), the security engine 240 determines whether an undesired event has occurred based on the analysis of the platform and/or sensor telemetry data. (Block 640). For example, exceeding operating temperatures does not by itself indicate that an undesired event has occurred, but a cyclic pattern of exceeding operating temperatures may indicate an undesired event. Other examples, such as exceeding force limits or detecting water damage, could lead to an immediate determination of an undesired event. Thus, different events and/or operating conditions can be weighted such that those events and/or operating conditions are treated independently of one another and are analyzed based on more than a single data point.

When the security engine 240 determines that no undesired event has occurred (e.g., block 640 returns a result of NO), the security engine 240 continues to analyze the platform and/or sensor telemetry data for undesired operating conditions. The analyzing of the information can be continual (e.g., every cycle of the compute device 110), cyclical (e.g., at a pre-defined cycle timing such as every day, every hour, etc.), or on a threshold detection basis (e.g., when a parameter such as a temperature exceeds a preliminary threshold which can lead to additional analysis of the parameter).

When the security engine 240 determines that an undesired event has occurred (e.g., block 640 returns a result of YES), the security engine 240 logs and/or indicates the undesired event in the ledger for storage in NVM. (Block 650). In examples disclosed herein, the logging/storing/indicating of information in the ledger can be done at any interval (e.g., continual, cyclic, etc.), and thus multiple events and/or operating conditions can be logged/recorded at once to compile the ledger prior to storing the updated ledger in NVM.

FIG. 7 is a block diagram of an example programmable circuitry platform 700 structured to execute and/or instantiate the example machine-readable instructions and/or the example operations of FIGS. 4, 5A, 5B, and/or 6 to implement the of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the sensor interface circuitry 210, the platform monitor circuitry 220, the UEFI circuitry 230, the security engine 240, the cloud communication circuitry 250, and the NVM communication circuitry 260.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a printer, etc. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4, 5A, 5B, and/or 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4, 5A, 5B, and/or 6 to effectively instantiate the blocks of FIG. 1 as logic circuits to perform operations corresponding to those machine readable instructions. In some such examples, the blocks of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4, 5A, 5B, and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4, 5A, 5B, and/or 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4, 5A, 5B, and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5A, 5B, and/or 6. As such, the FPGA circuitry 900 may be configured and/or structured to effectively instantiate some or all of the operations/functions corresponding to the machine readable instructions of the flowchart(s) of FIGS. 4, 5A, 5B, and/or 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4, 5A, 5B, and/or 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4, 5A, 5B, and/or 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 9. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4, 5A, 5B, and/or 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 4, 5A, 5B, and/or 6, and/or an ASIC may be configured and/or structured to perform third operation(s)/function(s) corresponding to a third portion of the machine readable instructions represented by the flowcharts of FIGS. 4, 5A, 5B, and/or 6.

It should be understood that some or all of the blocks of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the blocks of FIG. 1 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the blocks of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

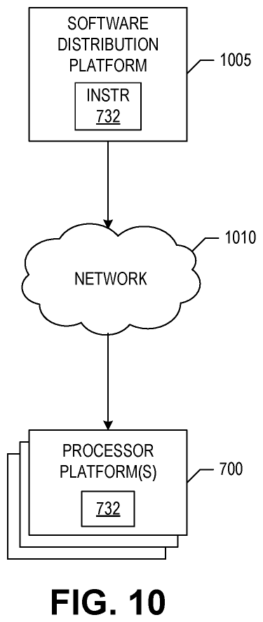

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4, 5A, 5B, and/or 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4, 5A, 5B, and/or 6, may be downloaded to the example programmable circuitry platform 700, which is to execute the machine readable instructions 732 to implement the example telemetry controller 115 of FIG. 2. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that manage and securely store platform service records for a compute device. Disclosed systems, apparatus, articles of manufacture, and methods improve the efficiency of using a computing device by securely signing and storing telemetry data that is persistent and impervious to unauthorized manipulation/deletion. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage and securely store platform service records are disclosed herein. Further examples and combinations thereof include the following:

Example 1 includes an apparatus for monitoring a compute device, the apparatus comprising interface circuitry, non-volatile flash memory, machine readable instructions, and programmable circuitry to at least one of instantiate or execute the machine readable instructions to analyze telemetry data obtained via a sensor of the compute device, the analyzing of the telemetry data to detect an undesired event, and storing, in response to detection of the undesired event, the telemetry data in a ledger, wherein the ledger is digitally signed to prevent unauthorized modification and stored in the non-volatile flash memory.

Example 2 includes the apparatus of example 1, wherein the digitally signed ledger is not accessible by a user of the compute device.

Example 3 includes the apparatus of example 1, wherein the programmable circuitry is to digitally sign the ledger.

Example 4 includes the apparatus of example 3, wherein the programmable circuitry is to decode the digitally signed ledger, the decoded ledger is used to analyze usage and wear of the compute device.

Example 5 includes the apparatus of example 1, wherein the programmable circuitry is to process ledger transmission requests from an external service, the external service to maintain a copy of the ledger.

Example 6 includes the apparatus of example 5, wherein the programmable circuitry is to communicate the ledger to the external service.

Example 7 includes the apparatus of example 1, wherein the programmable circuitry is to analyze the telemetry data and store the telemetry data in the ledger when the compute device is in use.

Example 8 includes the apparatus of example 1, wherein the programmable circuitry is to store an entry in the ledger indicating that an undesired event has occurred, wherein the entry is used to analyze usage and wear of the compute device.

Example 9 includes a non-transitory machine readable storage medium comprising instructions to cause programmable circuitry to at least analyze telemetry data obtained via a sensor of a compute device, the analyzing of the telemetry data to detect an undesired event, and store, in response to detection of the undesired event, the telemetry data in a ledger, the ledger to be digitally signed to prevent unauthorized modification of the ledger and stored in non-volatile flash memory.

Example 10 includes the non-transitory machine readable storage medium of example 9, wherein the digitally signed ledger is not accessible by a user of the compute device.

Example 11 includes the non-transitory machine readable storage medium of example 9, wherein the instructions cause the programmable circuitry to digitally sign the ledger.

Example 12 includes the non-transitory machine readable storage medium of example 11, wherein the instructions cause the programmable circuitry to decode the digitally signed ledger, the decoded ledger is used to analyze usage and wear of the compute device.

Example 13 includes the non-transitory machine readable storage medium of example 9, wherein the instructions cause the programmable circuitry to process ledger transmission requests from an external service, the external service to maintain a copy of the ledger.

Example 14 includes the non-transitory machine readable storage medium of example 13, wherein the instructions cause the programmable circuitry to communicate the ledger to the external service.

Example 15 includes the non-transitory machine readable storage medium of example 9, wherein the instructions cause the programmable circuitry to analyze the telemetry data and store the telemetry data in the ledger when the compute device is in use.

Example 16 includes the non-transitory machine readable storage medium of example 9, wherein the instructions cause the programmable circuitry to store an entry in the ledger indicating that an undesired event has occurred, wherein the entry is used to analyze usage and wear of the compute device.

Example 17 includes an apparatus comprising means for analyzing telemetry data obtained via a sensor of a compute device, the analyzing of the telemetry data to detect an undesired event, and means for storing, in response to detection of the undesired event, the telemetry data in a ledger, wherein the ledger is digitally signed to prevent unauthorized modification of the ledger and stored in non-volatile flash memory.

Example 18 includes the apparatus of example 17, wherein the means for storing the telemetry data in the ledger is a first means for storing, further including second means for storing the ledger in the non-volatile flash memory, wherein the digitally signed ledger stored in the non-volatile flash memory is not accessible by a user of the compute device.

Example 19 includes the apparatus of example 18, wherein the second means for storing is to decode the digitally signed ledger, wherein the decoded ledger is used to analyze usage and wear of the compute device.

Example 20 includes the apparatus of example 17, wherein the means for storing is to digitally sign the ledger.

Example 21 includes the apparatus of example 17, further including means for processing ledger transmission requests from an external service, the external service to maintain a copy of the ledger.

Example 22 includes the apparatus of example 21, wherein the means for processing is to communicate the ledger to the external service.

Example 23 includes the apparatus of example 17, wherein the means for analyzing and the means for storing are to preserve the telemetry data when the compute device is in use.

Example 24 includes the apparatus of example 17, wherein the means for storing is to store an entry in the ledger indicating that an undesired event has occurred, wherein the entry is used to analyze usage and wear of the compute device.

Example 25 includes a method comprising analyzing telemetry data obtained via a sensor of a compute device, the analyzing of the telemetry data to detect an undesired event, and storing, in response to detection of the undesired event, the telemetry data in a ledger, wherein the ledger digitally is signed to prevent unauthorized modification of the ledger and stored in non-volatile flash memory.

Example 26 includes the method of example 25, wherein the digitally signed ledger is not accessible by a user of the compute device.

Example 27 includes the method of example 25, further including signing, digitally, the ledger.

Example 28 includes the method of example 27, further including decoding the digitally signed ledger, wherein the decoded ledger is used to analyze usage and wear of the compute device.

Example 29 includes the method of example 25, further including processing ledger transmission requests from an external service, the external service to maintain a copy of the ledger.

Example 30 includes the method of example 29, further including communicating the ledger to the external service.

Example 31 includes the method of example 25, wherein analyzing the telemetry data and storing the telemetry data in the ledger occurs when the compute device is in use.

Example 32 includes the method of example 25, further including storing an entry in the ledger indicating that an undesired event has occurred, wherein the entry is used to analyze usage and wear of the compute device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus for monitoring a compute device, the apparatus comprising:
interface circuitry;
non-volatile flash memory;
machine readable instructions; and
programmable circuitry to at least one of instantiate or execute the machine readable instructions to:
analyze telemetry data obtained via a sensor of the compute device, the analyzing of the telemetry data to detect an undesired event; and
storing, in response to detection of the undesired event, the telemetry data in a ledger, wherein the ledger is digitally signed to prevent unauthorized modification and stored in the non-volatile flash memory.

2. The apparatus of claim 1, wherein the digitally signed ledger is not accessible by a user of the compute device.

3. The apparatus of claim 1, wherein the programmable circuitry is to digitally sign the ledger.

4. The apparatus of claim 3, wherein the programmable circuitry is to decode the digitally signed ledger, the decoded ledger is used to analyze usage and wear of the compute device.

5. The apparatus of claim 1, wherein the programmable circuitry is to process ledger transmission requests from an external service, the external service to maintain a copy of the ledger.

6. The apparatus of claim 5, wherein the programmable circuitry is to communicate the ledger to the external service.

7. The apparatus of claim 1, wherein the programmable circuitry is to analyze the telemetry data and store the telemetry data in the ledger when the compute device is in use.

8. The apparatus of claim 1, wherein the programmable circuitry is to store an entry in the ledger indicating that an undesired event has occurred, wherein the entry is used to analyze usage and wear of the compute device.

9. A non-transitory machine readable storage medium comprising instructions to cause programmable circuitry to at least:
analyze telemetry data obtained via a sensor of a compute device, the analyzing of the telemetry data to detect an undesired event; and
store, in response to detection of the undesired event, the telemetry data in a ledger, the ledger to be digitally signed to prevent unauthorized modification of the ledger and stored in non-volatile flash memory.

10. The non-transitory machine readable storage medium of claim 9, wherein the digitally signed ledger is not accessible by a user of the compute device.

11. The non-transitory machine readable storage medium of claim 9, wherein the instructions cause the programmable circuitry to digitally sign the ledger.

12. The non-transitory machine readable storage medium of claim 11, wherein the instructions cause the programmable circuitry to decode the digitally signed ledger, the decoded ledger is used to analyze usage and wear of the compute device.

13. The non-transitory machine readable storage medium of claim 9, wherein the instructions cause the programmable circuitry to process ledger transmission requests from an external service, the external service to maintain a copy of the ledger.

14. The non-transitory machine readable storage medium of claim 13, wherein the instructions cause the programmable circuitry to communicate the ledger to the external service.

15. The non-transitory machine readable storage medium of claim 9, wherein the instructions cause the programmable circuitry to analyze the telemetry data and store the telemetry data in the ledger when the compute device is in use.

16. The non-transitory machine readable storage medium of claim 9, wherein the instructions cause the programmable circuitry to store an entry in the ledger indicating that an undesired event has occurred, wherein the entry is used to analyze usage and wear of the compute device.

17. An apparatus comprising:
means for analyzing telemetry data obtained via a sensor of a compute device, the analyzing of the telemetry data to detect an undesired event; and
means for storing, in response to detection of the undesired event, the telemetry data in a ledger, wherein the ledger is digitally signed to prevent unauthorized modification of the ledger and stored in non-volatile flash memory.

18. The apparatus of claim 17, wherein the means for storing the telemetry data in the ledger is a first means for storing, further including second means for storing the ledger in the non-volatile flash memory, wherein the digitally signed ledger stored in the non-volatile flash memory is not accessible by a user of the compute device.

19. The apparatus of claim 18, wherein the second means for storing is to decode the digitally signed ledger, wherein the decoded ledger is used to analyze usage and wear of the compute device.

20. The apparatus of claim 17, wherein the means for storing is to digitally sign the ledger.

21-32. (canceled)
